(19) United States
(12) Patent Application Publication
(10) Pub. No.: US 2025/0050784 A1
(43) Pub. Date: Feb. 13, 2025

(54) SOLAR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/791,913

(22) Filed: Aug. 1, 2024

(30) Foreign Application Priority Data
Aug. 9, 2023 (JP) 2023-130053

(51) Int. Cl. B60L 58/12; B60L 8/00

(52) U.S. Cl. CPC B60L 58/12; B60L 8/003; B60L 2210/10; B60L 2240/547

(57) ABSTRACT

In a solar charging system, an auxiliary battery is supplied with power generated by a solar panel. Bidirectional DC-DC converters operate in a first state that the generated power of the solar panel and the power of the auxiliary battery are supplied to the driving battery of the vehicle, or in a second state that power of the driving battery is supplied to the auxiliary battery. The control unit operates in a first control mode in which the bidirectional DC-DC converter is controlled so that the voltage or SOC of the auxiliary battery is within the first range, or in a second control mode in which the bidirectional DC-DC converter is controlled so that the voltage or SOC of the auxiliary battery is within the second range wider than the first range. When solar charging is performed by the solar panel, the control unit operates in the second control mode.

### CROSS-REFERENCE TO RELATED APPLICATION

This application claims priority to Japanese Patent Application No. 2023-130053 filed on Aug. 9, 2023, incorporated herein by reference in its entirety.

### BACKGROUND

### 1. Technical Field

The present disclosure relates to a solar charging system.

### 2. Description of Related Art

A technique of charging an auxiliary battery and a driving battery using electric power generated by a solar panel mounted on a vehicle is known. Japanese Unexamined Patent Application Publication No. 2020-048286 (JP 2020-048286 A) discloses a vehicle charging control system that distributes electric power to a driving battery and an auxiliary battery at a first distribution proportion when the voltage of the auxiliary battery is equal to or greater than a predetermined value. JP 2020-048286 A also discloses a vehicle charging control system that distributes electric power to a driving battery and an auxiliary battery at a second distribution proportion at which the proportion of distribution to the auxiliary battery is higher than that at the first distribution proportion when the voltage of the auxiliary battery is less than a predetermined value.

### SUMMARY

The present inventor has recognized that in a solar charging system for a vehicle, there is a possibility that a loss of electric power increases in a situation in which solar radiation is unstable, as charging and discharging are repeatedly performed between an auxiliary battery and a driving battery.

An object of the present disclosure is to provide a solar charging system capable of reducing a loss of electric power.

In order to address the above issue, an aspect of the present disclosure provides a solar charging system including:
a solar panel;
an auxiliary battery to which electric power generated by the solar panel is supplied;
a driving battery for a vehicle;
a direct current (DC)-DC converter that operates in a first state in which the electric power generated by the solar panel and electric power of the auxiliary battery are supplied to the driving battery, or in a second state in which electric power of the driving battery is supplied to the auxiliary battery; and
a control unit that controls the DC-DC converter.
The control unit is configured to:
operate in a first control mode in which the DC-DC converter is controlled such that a voltage or a state of charge (SOC) of the auxiliary battery is within a first range, or in a second control mode in which the DC-DC converter is controlled such that the voltage or the SOC of the auxiliary battery is within a second range that is wider than the first range; and
operate in the second control mode when solar charging is performed by the solar panel.

According to the present disclosure, it is possible to provide a solar charging system capable of reducing a loss of electric power.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a solar charging system according to an embodiment;

FIG. 2 is a diagram illustrating an exemplary first range and a second range of SOC (state of charge) of the auxiliary battery of FIG. 1;

FIG. 3A is a diagram illustrating a state in which solar radiation is relatively large and power generated by a solar panel 10 is relatively large;

FIG. 3B is a diagram illustrating a state in which solar radiation is relatively low and power generated by a solar panel 10 is relatively low;

FIG. 3C is a diagram illustrating a state in which solar radiation is relatively small, power generated by a solar panel 10 is relatively small, and an auxiliary battery 14 is charged using power of a driving battery 20;

FIG. 4A is a diagram showing a state in which solar radiation is present and the solar panel 10 is generating electric power;

FIG. 4B is a diagram illustrating a state in which solar radiation disappears and the solar panel 10 no longer generates electric power;

FIG. 5A is a diagram illustrating a state in which the bidirectional DC-DC converters 18 are stopped;

FIG. 5B is a diagram illustrating a state of charging operation of an auxiliary battery 14; and

FIG. 6 is a flowchart illustrating a control process of the solar charging system.

### DETAILED DESCRIPTION OF EMBODIMENTS

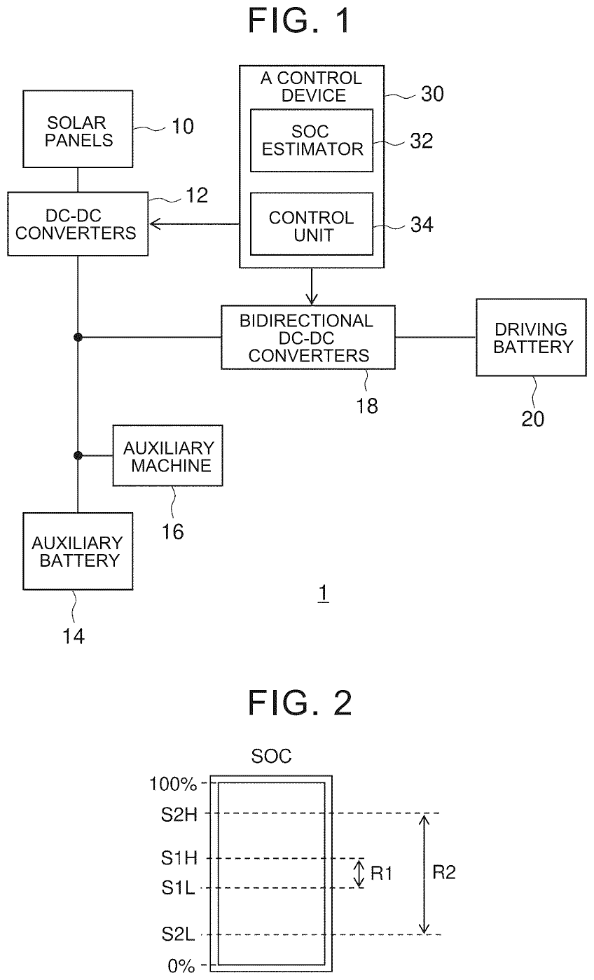

FIG. 1 schematically illustrates a configuration of a solar charging system 1 according to an embodiment. The solar charging system 1 is mounted on an electrified vehicle (not shown). Electrified vehicle may be, for example, a battery electric vehicle (BEV: Battery Electric Vehicle) using an electric motor as a power source, a hybrid electric vehicle (HEV: Hybrid Electric Vehicle), a plying hybrid electric vehicle (PHEV: Plug-in Hybrid Electric Vehicle), or a fuel cell electric vehicle (FCEV: Fuel Cell Electric Vehicle). Electrified vehicle may be a vehicle driven by a driver or an autonomous vehicle.

The solar charging system 1 includes a solar panel 10, a DC-DC converter 12, an auxiliary battery 14, an auxiliary machine 16, a bidirectional DC-DC converter 18, a driving battery 20, and a control device 30.

The solar panel 10 is a solar cell module that is an assembly of solar cells that generate electric power based on irradiated solar light. The power generated by the solar panel 10 depends on the solar radiation intensity. The solar panel 10 is connected to an input terminal of DC-DC converter 12. The electric power generated by the solar panel 10 is outputted to DC-DC converters 12. The solar panel 10 is installed in, for example, a roof of a vehicle.

An output terminal of DC-DC converter 12 is connected to the auxiliary battery 14, the auxiliary machine 16, and the bidirectional DC-DC converter 18. DC-DC converter 12 can convert the generated power of the solar panel 10 into electric power and supply the electric power to the auxiliary battery 14, the auxiliary machine 16, and the bidirectional DC-DC converter 18. DC-DC converters 12 step down or step up the output voltage of the solar panel 10 to a predetermined voltage under the control of the control device 30, and output the stepped down or boosted voltage to the auxiliary battery 14 or the like. DC-DC converters 12 provide MPPT (Maximum Power Point Tracking) control to maximize the power output of the solar panel 10.

The auxiliary battery 14 is, for example, a rechargeable secondary battery such as a lithium ion battery. The auxiliary battery 14 is a low-voltage battery having a voltage lower than that of the driving battery 20. The auxiliary battery 14 can be charged by electric power generated by the solar panel 10. The auxiliary battery 14 may be charged by the electric power of the driving battery 20. The auxiliary battery 14 is capable of supplying power to the auxiliary machine 16. The auxiliary battery 14 may charge the driving battery 20.

The auxiliary machine 16 is a load of an electronic device or the like provided in the vehicle. The auxiliary machine 16 may include, for example, a headlamp, a navigation device, an audio device, an air conditioner, an autonomous driving system, an advanced driving support system, and the like. The auxiliary machine 16 operates using electric power supplied from the auxiliary battery 14.

The bidirectional DC-DC converters 18 have a first terminal and a second terminal. The first terminal is connected to the output terminal of DC-DC converter 12 and the auxiliary battery 14. The second terminal is connected to the driving battery 20. The bidirectional DC-DC converters 18 operate in a first state in which the voltage at the first terminal is boosted and the voltage after the boosting is output from the second terminal, or in a second state in which the voltage at the second terminal is stepped down and the voltage after the boosting is output from the first terminal under the control of the control device 30.

The driving battery 20 is, for example, a rechargeable secondary battery such as a lithium ion battery. The driving battery 20 may also be referred to as a high voltage battery. The driving battery 20 can supply electric power to an electric motor that generates a driving force of the vehicle via an inverter (not shown) or the like. The driving battery 20 can be charged with electric power supplied from a charging station or the like outside the vehicle via an in-vehicle charging device (not shown).

The control device 30 controls DC-DC converter 12 and the bidirectional DC-DC converter 18 on the basis of an output voltage of the solar panel 10 detected by a voltage sensor and a current sensor (not shown), a voltage and a current of the auxiliary battery 14, a voltage of the driving battery 20, and the like. The control device 30 includes a SOC estimation unit 32 and a control unit 34.

The configuration of the control device 30 may be realized by hardware, a CPU of any computer, a memory, or another LSI, and may be realized by software, a program loaded into the memory, or the like. However, the functional blocks realized by the cooperation are illustrated here. Therefore, it is understood by those skilled in the art that these functional blocks can be implemented in various forms by hardware only, by software only, or by a combination of hardware and software.

SOC estimation unit 32 sequentially estimates the estimated value of SOC of the auxiliary battery 14 based on the voltage/current of the auxiliary battery 14, and sequentially supplies the estimated value of SOC to the control unit 34.

The control unit 34 controls the charging and discharging of the auxiliary battery 14 by controlling the bidirectional DC-DC converters 18 based on the received estimated SOC, the output voltage of the solar panel 10, the voltage and current of the auxiliary battery 14, and the voltage of the driving battery 20. Hereinafter, an estimate of SOC is simply referred to as a SOC.

The control unit 34 operates in the first control mode or the second control mode. The control unit 34 operates in the first control mode when the solar panel 10 is not solar-charged and the bidirectional DC-DC converters 18 are not operating in the first state. The control unit 34 operates in the second control mode when the solar panel 10 is solar-charging or when the bidirectional DC-DC converters 18 are operating in the first state. The solar charging corresponds to the power generation of the solar panel 10.

In the first control mode, the control unit 34 controls the bidirectional DC-DC converters 18 to be in the second state or the stopped state so that SOC of the auxiliary battery 14 falls within the first range. In the second control mode, the control unit 34 controls the bidirectional DC-DC converters 18 to be in the first state, the second state, or the stopped state so that SOC of the auxiliary battery 14 falls within the second range that is wider than the first range.

The control unit 34 may control the bidirectional DC-DC converters 18 so that the voltage of the auxiliary battery 14 falls within the first range or the second range. Alternatively, the control unit 34 may control the bidirectional DC-DC converters 18 such that the voltage of the auxiliary battery 14 is within the first range or the second range of voltages and SOC is within the first range or the second range of SOC.

FIG. 2 shows an exemplary first range RI and second range R2 of SOC of the auxiliary battery 14 of FIG. 1. The upper limit value S2H of the second range R2 is larger than the upper limit value S1H of the first range R1. The lower limit value S2L of the second range R2 is smaller than the lower limit value S1L of the first range R1.

The upper limit value S2H of the second range R2 may be larger than the upper limit value S1H of the first range R1, and the lower limit value S2L of the second range R2 may be equal to the lower limit value S1L of the first range R1. Alternatively, the upper limit value S2H of the second range R2 may be equal to the upper limit value S1H of the first range R1, and the lower limit value S2L of the second range R2 may be smaller than the lower limit value S1L of the first range R1.

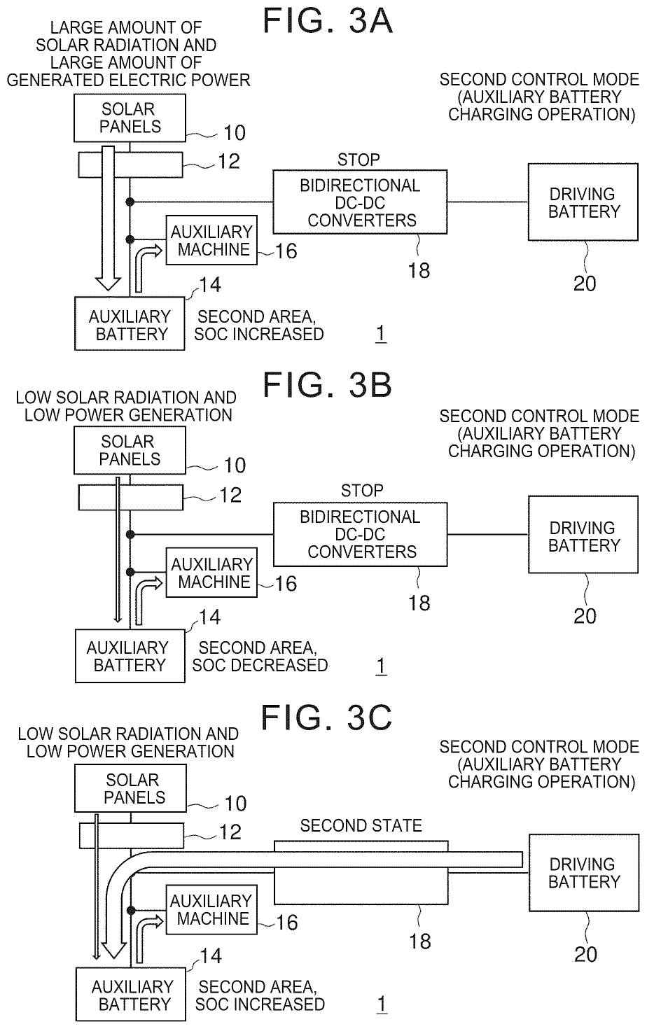

Next, the charging/discharging operation of the solar charging system 1 will be described referring to FIGS. 3A to 5B. In FIGS. 3A to 5B, the control device 30 is not illustrated.

### The Second Control Mode

FIGS. 3A to 3C are diagrams for explaining the charging operation of the auxiliary battery 14 in the second control mode. As described above, in the second control mode, SOC of the auxiliary battery 14 is controlled within the second range.

FIG. 3A shows a situation in which solar radiation is relatively large and the generated electric power of the solar panel 10 is relatively large. The bidirectional DC-DC converters 18 are controlled to be stopped. In FIG. 3A, it is assumed that the power generated by the solar panel 10 is larger than the power consumed by the auxiliary machine 16. Therefore, the auxiliary battery 14 is charged with the generated electric power, and SOC of the auxiliary battery 14 is increased. Since the auxiliary battery 14 can be charged using the energy of sunlight, convenience is high. In FIGS. 3A to 5B, an arrow indicates a power supply path, and a thickness of the arrow schematically indicates a magnitude of power.

If the condition changes from a situation where there is a relatively large amount of solar radiation to a situation where there is a relatively small amount of solar radiation, the condition shifts to the condition shown in FIG. 3B.

FIG. 3B shows a situation in which solar radiation is relatively small and the generated electric power of the solar panel 10 is relatively small. The bidirectional DC-DC converters 18 are controlled to be stopped. In FIG. 3B, it is assumed that the power generated by the solar panel 10 is less than the power consumed by the auxiliary machine 16. Therefore, SOC of the auxiliary battery 14 is reduced by the electric power consumed by the auxiliary machine 16. If the solar radiation recovers, it returns to the condition shown in FIG. 3A.

When the solar radiation does not recover and SOC of the auxiliary battery 14 reaches the lower limit of the second range, the operation shifts to the operation shown in FIG. 3C. That is, when solar charging is in progress, the control unit 34 controls the bidirectional DC-DC converters 18 to the second status so as to charge the auxiliary battery 14 when SOC of the auxiliary battery 14 reaches the lower limit of the second range. Specifically, when the bidirectional DC-DC converter 18 is stopped while the solar power is being charged, the control unit 34 controls the bidirectional DC-DC converter 18 to the second condition when SOC of the auxiliary battery 14 reaches the lower limit of the second range.

FIG. 3C shows a situation in which the solar radiation is relatively low, the generated power of the solar panel 10 is relatively small, and the auxiliary battery 14 is charged using the power of the driving battery 20 as well, following FIG. 3B. In the state of FIG. 3C, the bidirectional DC-DC converters 18 operate in a second state in which the power of the driving battery 20 is supplied to the auxiliary battery 14. Accordingly, the auxiliary battery 14 is charged by the electric power of the driving battery 20 and the electric power generated by the solar panel 10, and SOC of the auxiliary battery 14 is increased. Therefore, SOC of the auxiliary battery 14 can be increased even if the solar radiation is insufficient.

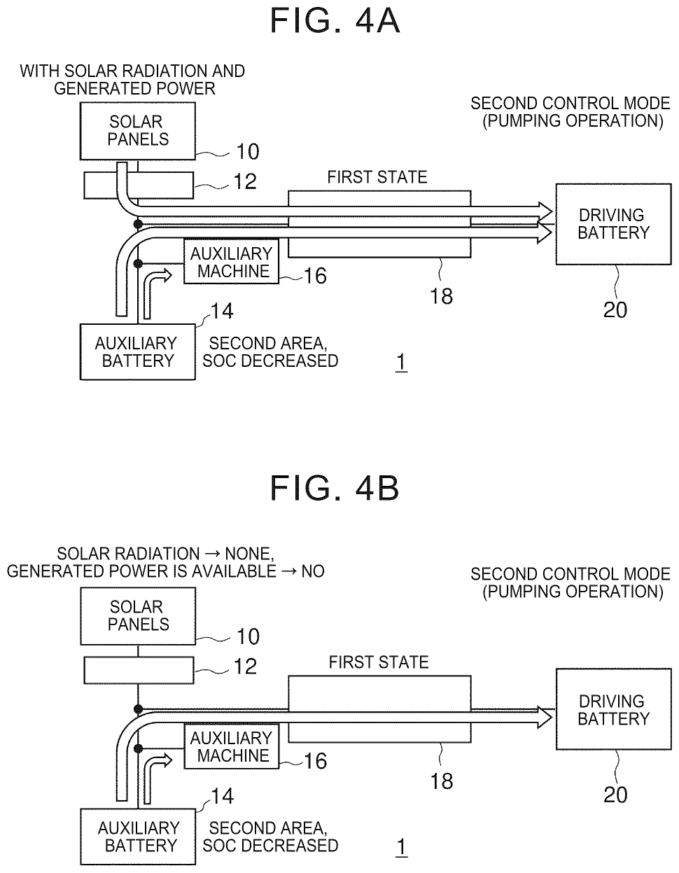

When SOC of the auxiliary battery 14 reaches the upper limit of the second range due to the charge, the operation shifts to the pumping operation in FIG. 4A.

On the other hand, when the solar radiation is relatively large in FIG. 3A, and SOC of the auxiliary battery 14 reaches the upper limit of the second range due to the electric power generated by the solar panel 10, the operation shifts to the pumping operation shown in FIG. 4A.

Specifically, when SOC of the auxiliary battery 14 reaches the upper limit of the second range during solar charging, the control unit 34 controls the bidirectional DC-DC converters 18 to the first state so as to charge the driving battery 20 with the generated electric power of the solar panel 10 and the electric power of the auxiliary battery 14.

FIGS. 4A and 4B are diagrams for explaining a pumping operation of the second control mode. FIG. 4A shows that solar radiation is present and the solar panel 10 is generating electricity. In the state of FIG. 4A, the bidirectional DC-DC converters 18 operate in a first state in which the generated power of the solar panel 10 and the power of the auxiliary battery 14 are supplied to the driving battery 20. As a result, the driving battery 20 is charged with the electric power of the auxiliary battery 14 and the electric power generated by the solar panel 10. This operation is called a pumping operation. SOC of the driving battery 20 is increased, and SOC of the auxiliary battery 14 is decreased. Since the driving battery 20 can be charged with the electric power generated by the energy of the sunlight and the electric power of the auxiliary battery 14 including the generated electric power, it is highly convenient and economical.

When SOC of the auxiliary battery 14 reaches the lower limit of the second range in the state shown in FIG. 4A, the operation of the above-described FIGS. 3A and 3B is shifted. That is, when the solar battery is being charged, the control unit 34 controls the bidirectional DC-DC converters 18 to be stopped so as to charge the auxiliary battery 14 with the generated electric power of the solar panel 10 when SOC of the auxiliary battery 14 reaches the lower limit of the second range. Specifically, the control unit 34 controls the bidirectional DC-DC converter 18 to be in a stopped state when SOC of the auxiliary battery 14 reaches the lower limit of the second range when the solar is being charged and the bidirectional DC-DC converter 18 is operating in the first state. Accordingly, the auxiliary battery 14 can be charged again using the generated electric power of the solar panel 10. When the solar radiation is enough, the driving battery 20 can be repeatedly charged by the electric power generated by the energy of the sunlight by alternately repeating the conditions of FIGS. 3A and 4A.

FIG. 4B shows a state in which solar radiation disappears and the solar panel 10 no longer generates electric power in the state of FIG. 4A. When the bidirectional DC-DC converters 18 are operating in the first state in the second control mode, that is, when the pumping operation is being performed, the control unit 34 continues the second control mode even when the solar charge is ended. Therefore, the bidirectional DC-DC converters 18 that continue the operation in the first status continue to supply the electric power of the auxiliary battery 14 to the driving battery 20. Therefore, SOC of the auxiliary battery 14 is reduced. When the second control mode is continued even after the solar charge is completed, the control unit 34 moves to the first control mode when SOC of the auxiliary battery 14 reaches the lower limit of the second range in the absence of the generated electric power of the solar panel 10.

This control allows the pumping operation to be continued even if the solar charging is completed during the pumping operation, and the power of the auxiliary battery 14 including the power generated by the solar panel 10 can be supplied to the driving battery 20 until the lower limit value of the second range is reached.

Further, even when the generated electric power of the solar panel 10 disappears during the charging operation of the auxiliary battery 14 of FIGS. 3A to 3C, the solar charging is terminated at that time. When the bidirectional DC-DC converters 18 are not operating in the first state in the second control mode, that is, when the pumping operation is not being performed, the control unit 34 moves to the first control mode when the solar charge ends.

Since the solar charge is controlled within the second range wider than the first range during the solar charge, when the solar charge ends and the second control mode ends, SOC of the auxiliary battery 14 may be in a relatively low exhausted state or a low charged state, or SOC of the auxiliary battery 14 may be in a relatively high charged state. If the battery is left in these conditions for a long time, the auxiliary battery 14 may deteriorate.

Therefore, when the voltage of the auxiliary battery 14 is higher than the predetermined first voltage or lower than the predetermined second voltage at the time when the second control mode is ended, the control unit 34 controls the bidirectional DC-DC converters 18 to adjust the voltage of the auxiliary battery 14. The second voltage is lower than the first voltage.

The first voltage may be a value corresponding to an upper limit value of the first range, or may be larger than a value corresponding to an upper limit value of the first range and smaller than a value corresponding to an upper limit value of the second range.

The second voltage may be a value corresponding to a lower limit value of the first range, or may be smaller than a value corresponding to a lower limit value of the first range and larger than a value corresponding to a lower limit value of the second range.

The value corresponding to the upper limit value of the first range represents the voltage of the auxiliary battery 14 at SOC of the upper limit value of the first range. The same applies to a value corresponding to the lower limit value of the first range. In a case where the first range and the second range are voltage ranges, the value corresponding to the upper limit value of the first range represents the upper limit value of the first range. The same applies to a value corresponding to the lower limit value of the first range.

Specifically, when the solar charge is completed and the voltage of the auxiliary battery 14 is higher than the first voltage, the control unit 34 controls the bidirectional DC-DC converters 18 to the first status until the voltage of the auxiliary battery 14 drops to a predetermined third voltage. As a result, the electric power of the auxiliary battery 14 is supplied to the driving battery 20, and the voltage of the auxiliary battery 14 decreases. The third voltage is lower than the first voltage and higher than the lower limit of the first range.

When the solar charge is completed and the voltage of the auxiliary battery 14 is lower than the second voltage, the control unit 34 controls the bidirectional DC-DC converters 18 to the second status until the voltage of the auxiliary battery 14 rises to a predetermined fourth voltage. As a result, the electric power of the driving battery 20 is supplied to the auxiliary battery 14, and the voltage of the auxiliary battery 14 increases. The fourth voltage is higher than the second voltage and lower than an upper limit value of the first range. The first voltage, the second voltage, the third voltage, and the fourth voltage can be appropriately determined by experiment or simulation.

As a result, it is possible to prevent the auxiliary battery 14 from being kept in an exhausted state, a low charge state, or a high charge state. Therefore, deterioration of the auxiliary battery 14 can be suppressed.

### The First Control Mode

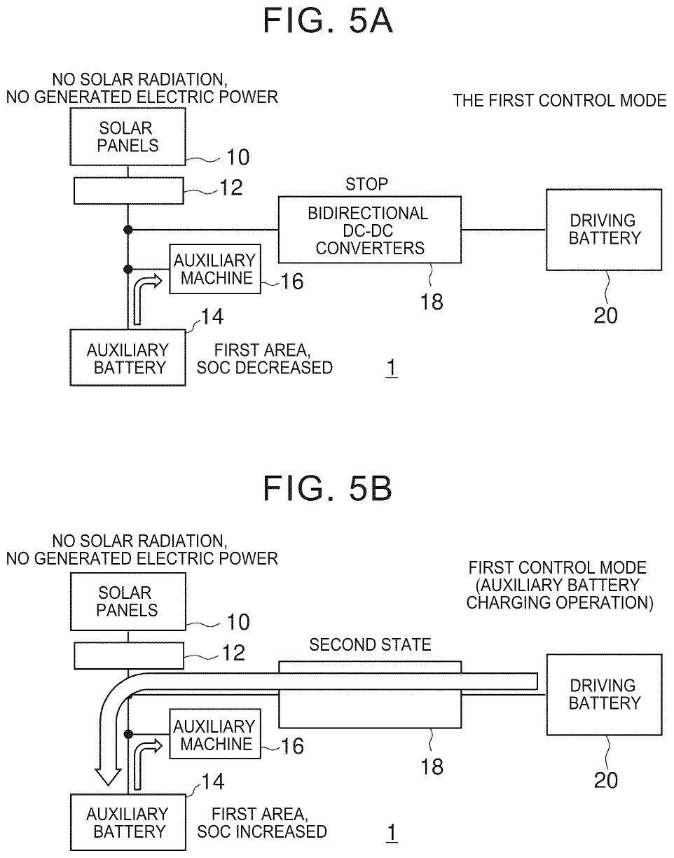

FIGS. 5A and 5B are diagrams for explaining the operation of the first control mode. As described above, in the first control mode, SOC of the auxiliary battery 14 is controlled within the first range.

FIG. 5A shows that the bidirectional DC-DC converters 18 are stopped. In the condition shown in FIG. 5A, since the solar panel 10 is not generating electricity, SOC of the auxiliary battery 14 is reduced due to the electricity consumed by the auxiliary machine 16.

When SOC of the auxiliary battery 14 reaches the lower limit of the first range, the operation shifts to the operation shown in FIG. 5B. Specifically, in the first control mode, when SOC of the auxiliary battery 14 reaches the lower limit of the first range, the control unit 34 controls the bidirectional DC-DC converters 18 to the second state.

FIG. 5B illustrates a state in which the auxiliary battery 14 is performing a charging operation. In the state of FIG. 5B, the bidirectional DC-DC converters 18 operate in a second state in which the power of the driving battery 20 is supplied to the auxiliary battery 14. As a result, the auxiliary battery 14 is charged with the electric power of the driving battery 20, and SOC of the auxiliary battery 14 is increased.

When SOC of the auxiliary battery 14 reaches the upper limit of the first range due to the charge, the operation returns to the operation shown in FIG. 5A. Specifically, in the first control mode, when SOC of the auxiliary battery 14 reaches the upper limit of the first range, the control unit 34 controls the bidirectional DC-DC converters 18 to be stopped.

In the first control mode, when the solar panel 10 starts power generation, solar charging is started. When the solar charging is started in the first control mode, the control unit 34 moves to the second control mode.

Here, a comparative example recognized by the present inventor will be described. The solar charging system of the comparative example has the same configuration as the solar charging system 1 of the embodiment, but has different control. In the comparative example, the control range of the common first range is used in the first control mode and the second control mode. That is, also in the second control mode, charging and discharging are controlled in the first range narrower than the second range of the embodiment.

In the second control mode, as shown in FIG. 3B, when solar radiation is reduced and the power generated by the solar panel is reduced, SOC of the auxiliary battery may be reduced due to the power consumed by the auxiliary machine. In the comparative example, since the upper limit value of the control range is low and the lower limit value is high in the second control mode as compared with the embodiment, SOC of the auxiliary battery can be lowered to the lower limit value in a shorter period of time. When SOC of the auxiliary battery drops to the lower limit, the auxiliary battery is charged with the generated electric power and the electric power of the driving battery as in FIG. 3C. In other words, when the solar radiation is unstable, the electric power that is once boosted by the pumping operation and stored in the driving battery from the auxiliary battery when the solar radiation is large can be reduced in voltage when the solar radiation is small and used for charging the auxiliary battery again as in FIG. 4A. At this time, the bidirectional DC-DC converters are lost in each of the step-up operation and the step-down operation.

The present inventors have recognized that, in the comparative example, in a situation where solar radiation is unstable, the power interchange between the auxiliary battery and the driving battery is repeated at a relatively high frequency, thereby increasing the loss of power.

In contrast to this comparative example, in the embodiment, since SOC of the auxiliary battery 14 is controlled within the second range wider than the first range during solar charging, the frequency of charging and discharging of the auxiliary battery 14 during solar charging can be reduced compared to the comparative example in a situation where solar radiation is unstable. That is, the frequency of power interchange between the auxiliary battery 14 and the driving battery 20 can be reduced as compared with the comparative example. Therefore, it is possible to reduce the loss of power generated by repeating charging and discharging.

Specifically, since the upper limit of the second range is higher than the first range, SOC of the auxiliary battery 14 can be higher than that of the comparative example during the solar charge shown in FIG. 3A. Therefore, the power available to the auxiliary machine 16 increases. Therefore, even when the solar radiation is reduced and FIG. 3B is reached, SOC of the auxiliary battery 14 is lowered to reach the lower limit of the second range. Further, even when the lower limit value of the second range is lower than the first range, SOC of the auxiliary battery 14 is lowered to reach the lower limit value of the second range in FIG. 3B in which the solar radiation is reduced.

From the above, SOC of the auxiliary battery 14 is less likely to reach the lower limit of the second range than in the comparative example. Therefore, the operation of charging the auxiliary battery 14 with the electric power of the driving battery 20 shown in FIG. 3C can be hardly performed. If the solar radiation recovers during FIG. 3B condition, SOC of the auxiliary battery 14 can be increased again by the generated electric power of the solar panel 10, so that the operation of FIG. 3C may not be performed.

In addition, when the solar battery is not being charged, SOC of the auxiliary battery 14 is controlled within a relatively narrow first area, so that the auxiliary battery 14 can be hardly deteriorated.

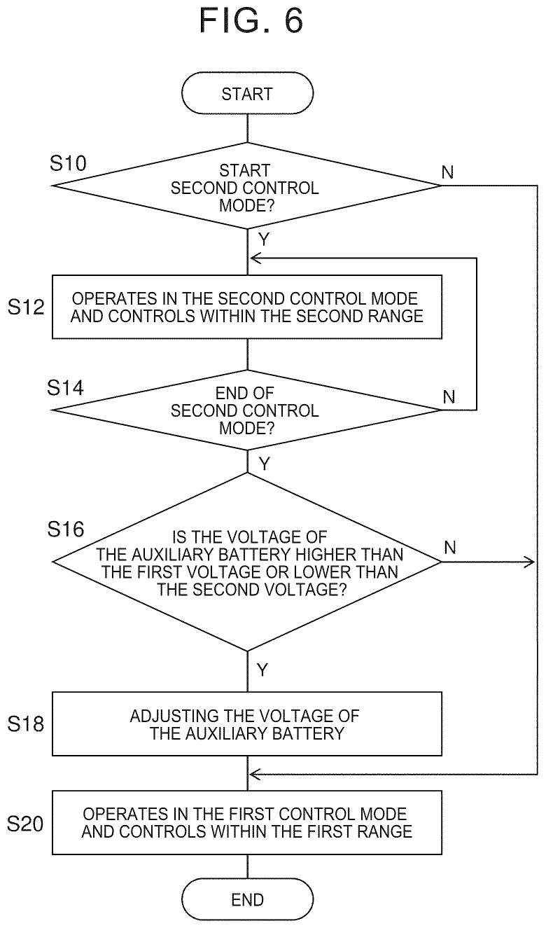

Next, an overall operation of the solar charging system 1 having the above-described configuration will be described. FIG. 6 is a flowchart illustrating a control process of the solar charging system 1. The process of FIG. 6 is repeatedly executed.

When the second control mode is not started (S10 N), the control unit 34 operates in the first control mode, controls SOC of the auxiliary battery 14 within the first range (S20), and ends the process.

When the second control mode is started (S10 Y), the control unit 34 operates in the second control mode and controls SOC of the auxiliary battery 14 within the second range (S12). When the second control mode is not ended (N in S14), the process returns to S12.

When the second control mode is ended (Y in S14), if the voltage of the auxiliary battery 14 is higher than the first voltage or lower than the second voltage (Y in S16), the control unit 34 controls the bidirectional DC-DC converter 18 to adjust the voltage of the auxiliary battery 14 (S18), and the process proceeds to S20. If S16 is not satisfied (N in S16), the process proceeds to S20.

The present disclosure has been described with reference to the embodiments. Note that the embodiments are merely an example. It is to be understood by those skilled in the art that various modifications are possible by combining the components and the processing processes and that such modifications are also within the scope of the present disclosure.

What is claimed is:

1. A solar charging system comprising:
a solar panel;
an auxiliary battery to which electric power generated by the solar panel is supplied;
a driving battery for a vehicle;
a direct current (DC)-DC converter that operates in a first state in which the electric power generated by the solar panel and electric power of the auxiliary battery are supplied to the driving battery, or in a second state in which electric power of the driving battery is supplied to the auxiliary battery; and
a control unit that controls the DC-DC converter, wherein the control unit is configured to:
operate in a first control mode in which the DC-DC converter is controlled such that a voltage or a state of charge (SOC) of the auxiliary battery is within a first range, or in a second control mode in which the DC-DC converter is controlled such that the voltage or the SOC of the auxiliary battery is within a second range that is wider than the first range; and
operate in the second control mode when solar charging is performed by the solar panel.

2. The solar charging system according to claim 1, wherein the control unit is configured to, when the solar charging is performed:
control the DC-DC converter to the second state or a stopped state so as to charge the auxiliary battery when the voltage or the SOC of the auxiliary battery reaches a lower limit value of the second range; and
control the DC-DC converter to the first state so as to charge the driving battery with the electric power generated by the solar panel and the electric power of the auxiliary battery when the voltage or the SOC of the auxiliary battery reaches an upper limit value of the second range.

3. The solar charging system according to claim 2, wherein the control unit is configured to:
when the solar charging is performed and the DC-DC converter is stopped, control the DC-DC converter to the second state when the voltage or the SOC of the auxiliary battery reaches the lower limit value of the second range;
when the solar charging is performed and the DC-DC converter is operating in the first state, control the DC-DC converter to the stopped state when the voltage or the SOC of the auxiliary battery reaches the lower limit value of the second range; and
in the first control mode, control the DC-DC converter to the second state when the voltage or the SOC of the auxiliary battery reaches a lower limit value of the first range, and control the DC-DC converter to the stopped state when the voltage or the SOC of the auxiliary battery reaches an upper limit value of the first range.

4. The solar charging system according to claim 1, wherein the control unit is configured to, when the second control mode is ended:
control the DC-DC converters to the first state when the voltage of the auxiliary battery is higher than a predetermined first voltage; and
control the DC-DC converter to the second state when the voltage of the auxiliary battery is lower than a predetermined second voltage that is lower than the first voltage.

5. The solar charging system according to claim 1, wherein the control unit is configured to:
when the DC-DC converter is not operating in the first state in the second control mode, transition to the first control mode when the solar charging is finished; and
when the DC-DC converter is operating in the first state in the second control mode, continue the second control mode even when the solar charging is finished, and transition to the first control mode when the voltage or the SOC of the auxiliary battery reaches a lower limit value of the second range.
